(19) United States
(12) Patent Application Publication
(10) Pub. No.: US 2024/0152460 A1
(43) Pub. Date: May 9, 2024

(54) METHODS AND APPARATUS TO PERFORM CACHE SCRAPING

(71) Applicant: Intel Corporation, Santa Clara, CA (US)

(72) Inventors: John J. Browne, Limerick (IE); Kshitij Arun Doshi, Tempe, AZ (US); Thijs Metsch, Bruehl (DE); Francesc Guim Bernat, Barcelona (ES); Adrian Hoban, Cratloe (IE)

(21) Appl. No.: 18/545,933

(22) Filed: Dec. 19, 2023

(51) Int. Cl. G06F 12/0842

(52) U.S. Cl. CPC G06F 12/0842

(57) ABSTRACT

An example disclosed apparatus comprises a trigger monitor to detect an event satisfying a cache scrape trigger rule during execution of a workload, and a cache scraper to scrape cache data from cache in hardware during the execution of the workload.

### FIELD OF THE DISCLOSURE

This disclosure relates generally to computers and, more particularly, to methods and apparatus to perform cache-scraping.

### BACKGROUND

Caches are used in computing to temporarily store frequently accessed or recently used data. Accessing data from cache allows data to be quickly retrieved when needed, reducing the need to access the original sources of the data, which can be slower. Central processing unit (CPU) caches store frequently accessed instructions and/or data to reduce memory access times.

### BRIEF DESCRIPTION OF THE DRAWINGS

FIG. 1 is a block diagram of an example environment in which an example cache scrape trigger rule controller, cache software monitor, and cache hardware monitor operate to perform directed cache scraping.

FIG. 2 is a block diagram of an example implementation of the cache scrape trigger rule controller of FIG. 1.

FIG. 3 is a block diagram of an example implementation of the cache software monitor of FIG. 1.

FIG. 4 is a block diagram of an example implementation of the cache hardware monitor of FIG. 1.

FIG. 5 is a flowchart representative of example machine readable instructions and/or example operations that may be executed, instantiated, and/or performed by example programmable circuitry to implement the cache scrape trigger rule controller of FIG. 2, the cache software monitor of FIG. 3 and/or the cache hardware monitor of FIG. 4.

FIG. 6 is a block diagram of an example processing platform including programmable circuitry structured to execute, instantiate, and/or perform the example machine readable instructions and/or perform the example operations of FIG. 5 to implement the cache scrape trigger rule controller of FIG. 2, the cache software monitor of FIG. 3 and/or the cache hardware monitor of FIG. 4.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The ability to scrape cache and collect cache data is useful for cache management and optimization. Cache data can be used to determine content compressibility, addresses that are frequently visited, spread of cache content among applications, degree of contention for caching resources (e.g., hardware and software). Cache uses metadata to track the status and content of cache entries. Metadata includes information such as timestamp of the last access, the size of a data, and other attributes. Metadata helps a cache management system to decide which data to keep in the cache, which data to remove, and which data to update. Metadata provides information about the data being cached, helping to manage and optimize the caching process.

Cache content compressibility is the ability to compress data that is stored in cache. The purpose of compressing cache data is to reduce the memory or storage space required to store the cache content in situation where memory or storage capacity is limited. A smaller compressed data can also lead to faster access times when retrieving data from the cache.

Understanding addresses that are frequently visited, such as a location in random access memory (RAM) or a cache line, is useful for cache management and optimization. For example, a cache might use a least recently used (LRU) algorithm that relies on metadata to determine which addresses have not been accessed recently. Addresses that are frequently accessed are sometimes referred to as having a greater address hotness than less frequently accessed addresses. Monitoring address hotness is useful to increase the likelihood that more frequently accessed data is available in cache to increase cache hit rates and decrease cache misses. By basing cache management on address hotness, systems can achieve better performance and reduce the time required to access frequently used data, which is useful in improving the efficiency of computer systems and/or applications.

The spread of cache content among applications refers to how cached data is distributed or shared across different software applications or processes in a computing system. Understanding the spread of cache content can be used to set quality of service (QoS) guarantees for specific applications so that such applications receive a certain portion of cache space or cache resources to maintain their performance. Users can also assign different priority levels to applications and cache management algorithms can use these priorities to determine which applications get preference when allocating cache space. Managing the spread of cache content among applications increases the likelihood that frequently used data is readily available for applications, improving system performance, and decreasing cache contention among applications.

Cache contention refers to the extent to which multiple processes and/or applications are competing for access to and use of a shared cache or cache resource in a computer system. Cache contention leads to bottlenecks and reduced efficiency. The degree of contention for caching resources can be assessed in multiple way. For example, analyzing a cache hit rate can reveal low cache hit rates and high cache hit rates. A low cache hit rate indicates a high degree of contention based on a substantial number of requests for data leading to cache misses due to the requested data not being located in the cache. This results in retrieval of the data from slower memory such as RAM or storage. A low cache hit rate also means that there is a high cache miss rate. The high cache miss rate signifies a high degree of contention based on cache misses occurring when multiple processes compete for cache access. Another measure is cache occupancy. A high cache occupancy can lead to contention as processes struggle to find space in the cache for their data. Contention can lead to increased cache access latency, as processes wait for access to cache lines, leading to delays in data retrieval. To address the degree of contention for cache resources, it is useful to understand the applications and/or workloads based on observations of past performance. Such understanding can be used to allocate the cache resources in a selective manner to specific processes to reduce contention. For example, in cases of high contention, the cache management system can flush or evict a portion of cache after a period of time.

Examples disclosed herein may be used to implement hardware and software architectural extensions to both perform cache-scraping operations declaratively through orchestration and to perform the construction of follow-on scraping actions. Examples disclosed herein enable a user to define cache scraping rules and direct the cache scraping actions or tasks based on occurrences of events detected in software and/or hardware. Unlike prior solutions that do not perform cache scraping operations due to lacking privileges to gain access to cache through an in-target probe, examples disclosed herein enables such cache access by using secure enclaves or trusted domains that have the needed credentials for access. The credentials are audited subject to physical unclonable function (PUF) challenge-response verifications. The credentials are also frequently refreshed to decrease the likelihood that they will be trojaned even through hardware intrusion.

The ability to declare and direct cache scraping (e.g., perform correlated sampling over cache contents), aggregate results, and provide insights without violating security or side-channel concerns enable entities or users to perform wide-area cache sweeping studies and use cache-scraping results in managing quality of service.

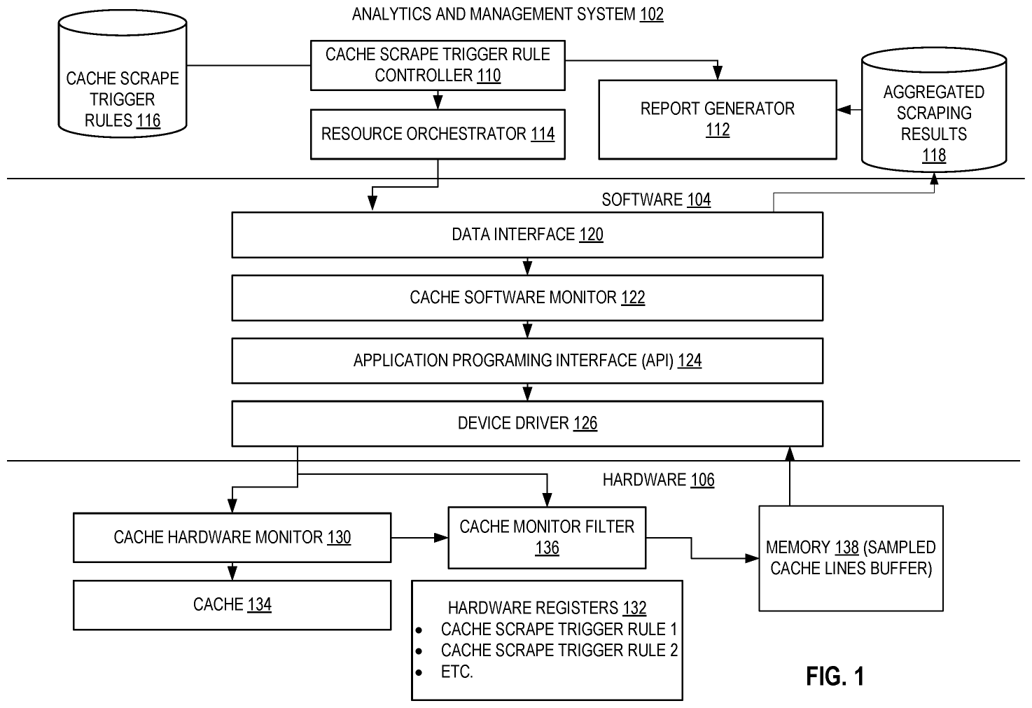

FIG. 1 is a block diagram of an example environment 100 in which an example cache scrape trigger rule controller 110, an example cache software monitor 122, and an example cache hardware monitor 130 operate to perform cache scraping based on cache scraping rules. The illustrated example environment 100 includes an analytics and management system 102, a software layer 104 and a hardware layer 106.

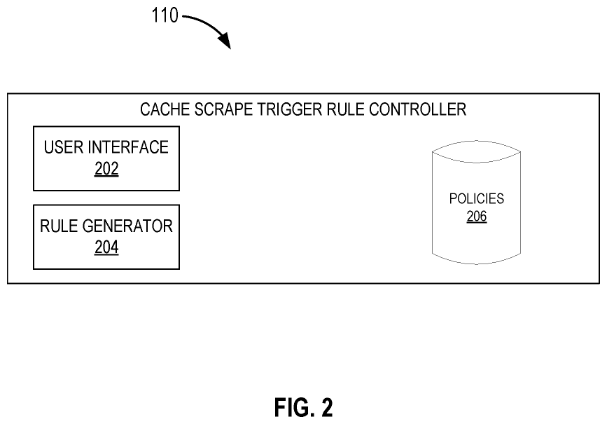

The example analytics and management system 102 provides management of cache scrape trigger rules for cache resources and analyzes scraped cache data. The example analytics and management system 102 includes the example cache scrape trigger rule controller 110, an example report generator 112, an example resource orchestrator 114, an example cache scrape trigger rules repository 116 and an example aggregated scraping results database 118. The example cache scrape trigger rule controller 110 is described in more detail below in connection with FIG. 2.

The example report generator 112 operates to generate a cache report based on cache data. The example report generator 112 receives cache data of cache lines sampled during execution of a workload. The example report generator 112 maps the cache data to a corresponding cache scraping event. A cache scraping event is based on software and/or hardware conditions satisfying a cache scrape trigger rule defined by a user. The cache data scraped during execution of the workload provides a virtual memory address corresponding to the workload and a physical memory address. The example report generator 112 can include such virtual and physical memory addresses in a cache report. This allows users to understand active memory locations that resulted in the cache content. Examining physical addresses corresponding to data stored in a cache is useful to understand cache behavior, improve cache utilization, and improve efficiency in retrieval of data from the cache. However, examining cache content in terms of physical address only allows static analysis (e.g., where data in cache is loaded from or stored to), but does not provide information of what processes or applications are causing that data to be stored. Understanding which applications or processes are causing data to be cached and which data is retrieved from which cache during execution of a workload, allow users to improve performance of cache usage, reduce storage requirements and minimize data transfer times. The cache report provides information of which cache data to compress to more efficiently use storage space and reduce usage of slower memory accesses by caching frequently accessed data. Compressing cache contents reduces cache space needed to store such contents, which allows for more data to be cached in the same amount of cache space. This can lead to better cache hit rates and faster data access rates.

The data collected from cache scraping can be a valuable tool for detecting potential issues and ensuring service level agreement (SLA) compliance. The cache content in SLA monitoring refers to the data stored in caches that may impact the performance of a service and/or the compliance with SLA commitments. The cache report can show if a cache contains outdated or incorrect data, which can lead to slow response times and/or service disruptions, violating SLA commitments related to response times. Cache scraping could also be used to check the consistency and/or correctness of the data stored in the cache. By validating that cached content matches the source data or the expected data, the example resource orchestrator 114 can ensure that the cache does not contain outdated or inaccurate information that could adversely affect SLA compliance. For example, the cache scraping and the cache report generated can be used to highlight instances when data that should be in the cache is not present. Cache misses can lead to increased latency, as data needs to be fetched from the original source (e.g., from memory having a slower access speed than cache). Detecting these cache misses can be used to increase the likelihood that the response times specified in SLA commitments are met. Cache scraping is also useful for root cause analysis when SLA is breached. The cache report pinpoints whether cache content played a role in the performance degradation and assists in diagnosing and resolving the issue. Cache scraping for SLA monitoring is useful to maintain cache data in alignment with service level commitments, thereby adhering to SLA terms.

The cache report can also be used to resolve cache resource contention. Cache resource contention occurs when multiple applications or processes compete for access to limited cache in a computing system. When an application is resource-intensive and monopolizes the cache, the application can cause contention, leading to performance degradation for other applications sharing the same cache. In a multi-process environment, simultaneous access to cache resources by multiple processes can lead to contention. Resource contention for cache memory can result in cache evictions and cache misses, leading to increased latency and reduced overall system performance. Contention can lead to slower data access, longer response times, and decreased cache hit rates, affecting the efficiency of the cache. The cache report can be used to detect cache contention issues by tracking cache hit rates, cache utilization and cache access patterns. From the cache report, users can understand the access patterns and behaviors of applications and allocate the right resources so that each application receives the cache resources it requires and to substantially reduce or eliminate performance degradation caused by contention.

By monitoring cache access patterns and cache content, the example resource orchestrator 114 can identify and address performance issues caused by noisy neighbors. For example, the results from cache scraping can be used to detect and mitigate noisy neighbors in shared computing environments to improve fair resource allocations and maintain consistent system performance. Noisy neighbors are applications or processes that consume an excessive amount of resources, leading to performance degradation for other applications sharing the same environment. Cache scraping can be used to actively monitor and analyze the content stored in caches, to detect the effects of noisy neighbors on cache data. For example, if a noisy-neighbor's resource-intensive operations lead to cache evictions or increased cache misses, cache scraping can be used to identify the associated cache degradation and provide insights into the root cause(s). Cache scraping can also be used to determine whether noisy neighbors are causing stale data in the cache due to their resource-intensive activities.

In some examples, the cache report can be used in a distributed computing environment to optimize system performance, especially in scenarios where caching is an integral part of the architecture. In a distributed computing environment, a load balancer is used to evenly distribute incoming requests among multiple cache servers. This helps distribute cache-related requests evenly to prevent overloading a single cache or resource, ensuring that workload is well-balanced and that no single cache or resource becomes a performance bottleneck. Load balancing cache servers improves cache performance and reduces contention that may occur when a single cache server receives excessive requests. Cache scraping can be used to monitor the cache content and integrity of cache data on each cache server. This can be used to maintain data consistently across multiple cache servers, which improves for load balancing performance. When a load balancer performs dynamic load adjustment, in which the load balancer allocates more traffic to cache servers based on their performance and resource availability, cache scraping can be used to provide real-time insights into the cache content and performance. The information provided by a cache report from cache scraping can be used to configure a load balancer to make informed decisions on traffic distribution.

The cache report provides information of cache content to support distribution of workloads. For example, the cache report may be useful in workload placement, often referred to as workload distribution or task scheduling. Workload placement involves the allocation and scheduling of tasks or workloads across computing resources to optimize resource utilization, balance loads on various components and improve efficiency of task execution to meet performance and operational requirements. The cache report provides information on cache resources that can be used to distribute resource according to more effective distributions to reduce cache contention and improve cache utilization.

In the illustrated example, the cache report helps to efficiently manage the use of cache memory or storage in a computer system to improve performance and resource utilization. Cache management includes monitoring cache hit rates, cache misses, and cache utilization. Cache is managed to ensure cache data is updated and consistent across the network. Metadata which includes information about the version or the state of the data can be used to check for cache consistency and to update cache contents. Cache utilization can be optimized by considering data access patterns and the cache size as shown in the cache report.

When a trigger condition such as context switching increases the cache miss rate, the cache report provides information of processes causing frequent context switching. The cache management system utilizes the cache report to reduce the frequency of context switching and improve cache utilization by assigning a specific CPU core to the process that is frequently used and by evicting cache contents that are not providing the expected benefits from caching. The cache contents that are evicted can be referred to as offenders. These cache contents include data having poor spatial or temporal locality, leading to frequent cache misses. Poor spatial locality occurs when a program accesses cache locations that are not close to each other in terms of address proximity. This leads to inefficient use of the cache system. Poor temporal locality occurs when a program does not repeatedly access the same memory locations over a short period. If a program does not exhibit temporal locality and frequently accesses different cache locations without revisiting the same locations, the cache may constantly evict useful data that could be reused shortly. As a result, the cache becomes less effective at storing frequently accessed data.

The example resource orchestrator 114 is provided to manage cache resources and cache scraping tasks based on cache scrape trigger rules defined as a policy. The example resource orchestrator 114 allocates, configures, and improves the use of cache resources to enhance system performance. The example resource orchestrator 114 allocates cache resources to applications or processes based on their needs and priorities to ensure that critical data is cached while optimizing cache utilization. Where a specific process is bound to a particular CPU core, the example resource orchestrator 114 maintains or locks the data in cache for the particular application process for a duration of time. The example resource orchestrator 114 can distribute cache requests and data efficiently across multiple cache, reducing the risk of cache overutilization. The example resource orchestrator 114 can adjust cache resource allocations based on changing workloads and application demands. In some examples, the resource orchestrator 114 disables caching and performs direct writes to dynamic random access memory (DRAM) for processes that directly impact the memory-mapped control registers or device memory. The example resource orchestrator 114 may determine if higher cache per core or higher bandwidth per core is to be added based on the cache report.

The example aggregated scraping results database 118 stores aggregated scraping results from hardware cache. In some examples, the cache results can be sampled cache lines. The aggregated cache results are used to generate the cache report.

The example cache scrape trigger rules repository 116 is to store cache scraping rules defined by users and/or organizations. The cache scraping rules are to direct cache scraping tasks based on the occurrence(s) of conditions specified in those rules.

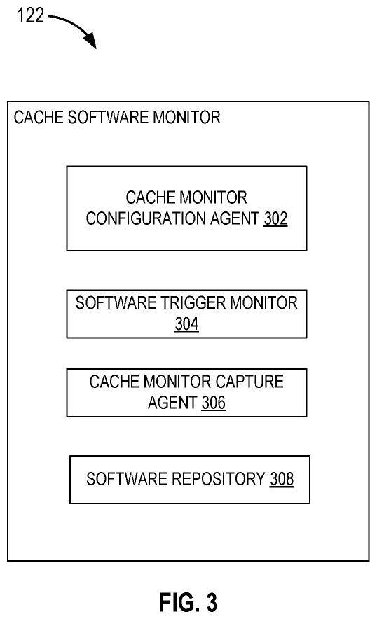

The example software layer 104 includes software execution which can generate multiple conditions useable to define cache scraping triggers to perform cache scraping. The example software layer 104 includes an example data interface 120, an example cache software monitor 122, an example application programming interface 124, and an example device driver 126. The example cache software monitor 122 is described in more detail below in connection with FIG. 3.

The example data interface 120 is used by software executing in the software layer 104 interacts with the analytics and management system 102 and retrieves cache scrape trigger rules from the example resource orchestrator 114.

The example application programming interface (API) 124 is used by software executing in the software layer 104 to interact with the hardware layer 106 and control hardware components such as the hardware register 132 and cache 134.

The example device driver 126 enables an operating system (OS) to use and control hardware devices. For example, the device driver 126 is a software component that interfaces between the OS in the software layer 104 and a hardware device of the hardware layer 106. The example device driver 126 translates OS commands and requests into device-specific commands and configurations. The example device driver 126 sends cache scrape trigger rules via the API 124 to the hardware register 132. The example API 124 communicates with the hardware layer 106 via a secure enclave or trusted domain established between the software layer 104 and the hardware layer 106.

The example hardware layer 106 performs cache scraping. The example hardware layer 106 includes an example cache hardware monitor 130, example hardware registers 132, an example cache 134, an example cache monitor filter 136 and an example memory 138.

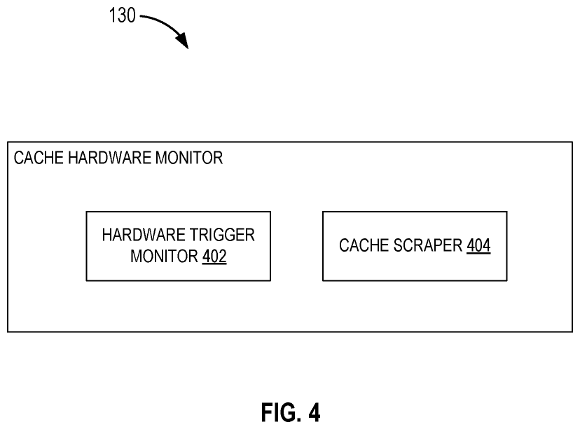

The example cache hardware monitor 130 monitors hardware to detect conditions that trigger cache scrape operations based on cache scrape trigger rules. After detecting a trigger event based on one or more conditions in a cache scrape trigger rule being satisfied, the cache hardware monitor 130 performs a cache scrape. Alternatively, the cache hardware monitor 130 may perform a cache scrape based on a cache scrape request received from the software layer 104. The example cache hardware monitor 130 is described in more detail below in connection with FIG. 4.

The example hardware registers 132 are configurable to represent cache scrape trigger rules to perform cache scraping tasks based on different software and hardware conditions satisfying the cache scrape trigger rules during execution of a workload. For example, timing parameters, cache region parameters, and/or trigger conditions defined in cache scrape trigger rules can be written to the hardware registers 132. The timing parameters may be used to specify one or more periodic time intervals to perform cache scraping. If cache scraping is not to be performed at periodic intervals, this may be set to zero. The cache region parameters indicate a portions of cache to scrape. The trigger conditions specify conditions that will trigger cache scrape operations. In examples disclosed herein, the cache hardware monitor 130 securely accesses the hardware registers 132 via a secure enclave or trusted domain. The secure enclave provides a trusted execution environment that can protect sensitive code and data from unauthorized access or tampering. The secure enclave defines an interface for accessing the hardware registers 132. This interface should encapsulate the necessary operations for reading from or writing to the hardware registers 132 while maintaining security. The secure enclave ensures that data transfer is encrypted and prohibits unauthorized access to the hardware registers 132. Using a secure enclave increases the likelihood that the hardware registers 132 receive cache scrape trigger rules only from trusted entities.

The example cache 134 is used to store data and instructions, allowing a CPU to quickly retrieve and process information without having to access slower main memory (e.g., RAM or hard drives). The cache 134 is divided into fixed-size blocks called cache lines. Data and instructions are stored in these cache lines. By scraping the cache lines, a user can observe which cache lines are accessed and when, to infer information about the data being processed during execution of a workload.

The example cache monitor filter 136 operates to track data or events in a cache. The example cache monitor filter 136 is used to observe and capture cache-related activities of interest. The example cache monitor filter 136 allows focusing on specific data or events of interest for analyzing.

The example memory 138 stores the filtered cache lines from the cache hardware monitor 130. The stored cache lines in the example memory 138 are accessed by the analytics and management system 102 to generate a cache report and cache-based insights for users.

FIG. 2 is a block diagram of an example implementation of the cache scrape trigger rule controller 110 of FIG. 1 to [generate cache scraping rules. The cache scrape trigger rule controller 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the cache scrape trigger rule controller 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example cache scrape trigger rule controller 110 includes an example user interface 202, an example rule generator 204 and example policies 206. The example cache scrape trigger rule controller 110 generates cache scrape trigger rules. A user inputs criteria via the example user interface 202. The example rule generator 204 operates to define the cache scrape trigger rules based on the provided criteria. The cache scrape trigger rule is generated and saved as a policy in the policies repository 206 used across different cache resources either locally on a local CPU and/or remotely for cache in resources connected via a network. Cache scrape trigger rules can be software-based cache scrape trigger rules and/or hardware-based cache scrape trigger rules. A software-based cache scrape trigger rule is defined using one or more conditions that occur in the software layer 104. A hardware-based cache scrape trigger rule is defined using one or more conditions that occur in the hardware layer 106. In some examples, a cache scrape trigger rule may be a hybrid cache scrape trigger rule that is defined by conditions in both the software layer 104 and in the hardware layer 106. For example, a hybrid cache scrape trigger rule causes a cache scrape operation when one or more defined software conditions and one or more defined hardware conditions are satisfied. The example resource orchestrator 114 (FIG. 1) applies the policies to various cache resources based on specified criteria. For example, a user can specify to scrape a cache based on certain conditions being satisfied. By performing cache scraping tasks based on specific conditions, users can analyze cache utilization during execution of a workload.

A cache scrape trigger rule can include timing and trigger conditions that are to cause performance of a scraping operation. Examples of trigger conditions include per-process address space identifier (PASID) context switches, per-PASID writes, cache age, cache hotness, cache flush events, cache access pattern, cache hit, cache miss, application-level service level objective (SLO) miss, etc. Context switch is when a processor switches from one process to another. When a context switch occurs, the cache data of the current process is flushed or evicted, and new data from the new process is loaded. Constantly evicting and reloading data in the cache can result in cache misses, which means the CPU has to fetch requested data from slower main memory. Cache age refers to the amount of time that data or information has been stored in a cache. Cache hotness represents the degree to which specific data or items are frequently accessed and kept in cache data that is accessed more frequently or in high demand by applications is considered “hot” or having a high cache hotness. Cache hit rate is a metric that quantifies cache hotness. For example, cache hit rate measures the percentage of cache accesses that result in cache hits (e.g., the requested data is found in the cache). A high cache hit rate indicates that a huge portion of the accessed data is hot and efficiently served from the cache rather than from slower memory. A cache flush event refers to the process of emptying the contents of a cache. A cache flush event occurs to remove outdated or invalid data from cache. It can also be triggered by a system administrator or application to perform debugging, troubleshooting, or triggered by hardware events, such as a system reset or power cycle. Cache flush events can also be utilized to synchronize data between different caches. Cache access patterns describe how data is accessed in a cache, the sequence and frequency that data or memory addresses are retrieved from the cache. Cache miss occurs when a requested data or instruction is not found in the cache memory. An application-level SLO miss measures the quality of service provided by an application. The SLO can be used to ensure that the application meets certain standards and delivers the expected level of service to users. Although examples of specific trigger conditions are disclosed herein, any other trigger conditions may additionally or alternatively be used.

In addition to specific trigger event resulting in cache scrape, a user can also specify timing trigger conditions. The timing trigger conditions perform periodic scraping based on time interval.

In addition to the various trigger conditions, a user can specify in a cache scrape trigger rule the types of cache scrape tasks to be performed based on different trigger conditions being satisfied. For example, different types of cache scrape tasks include sample cache lines, full cache dump to a secure enclave region, encrypt cache dumps or samples with pre-established keys and stream encrypted material via a shared memory to data lakes for further processing. Sampling cache lines refer to inspecting the data stored within the cache lines at specific intervals to gather information about cache usage and data patterns. Cache dump refers to the process of extracting the contents of a cache memory to an external storage medium.

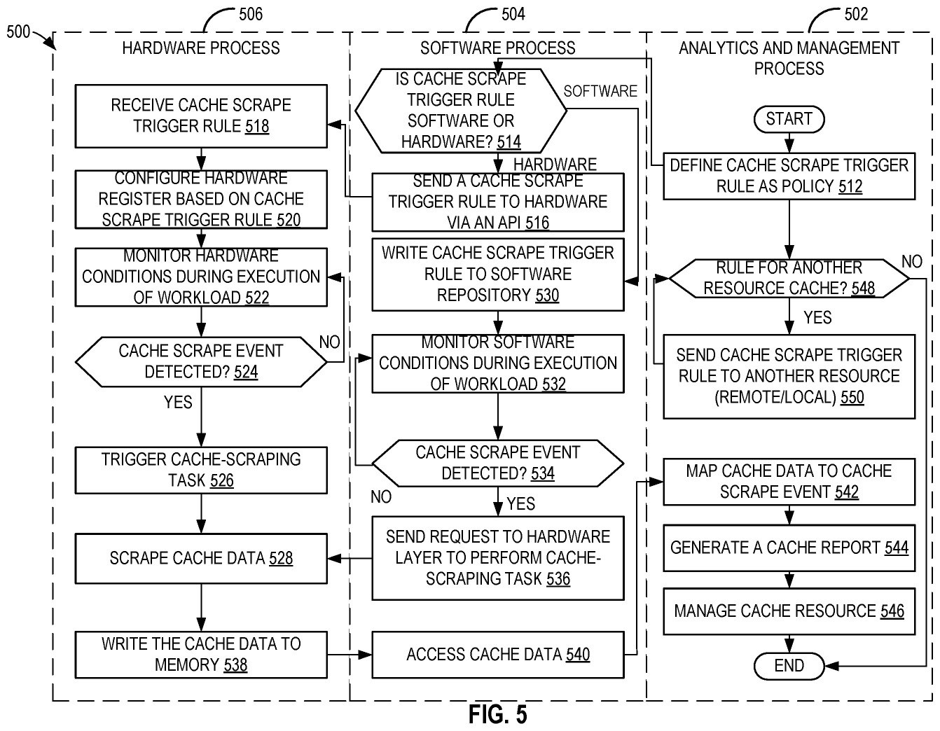

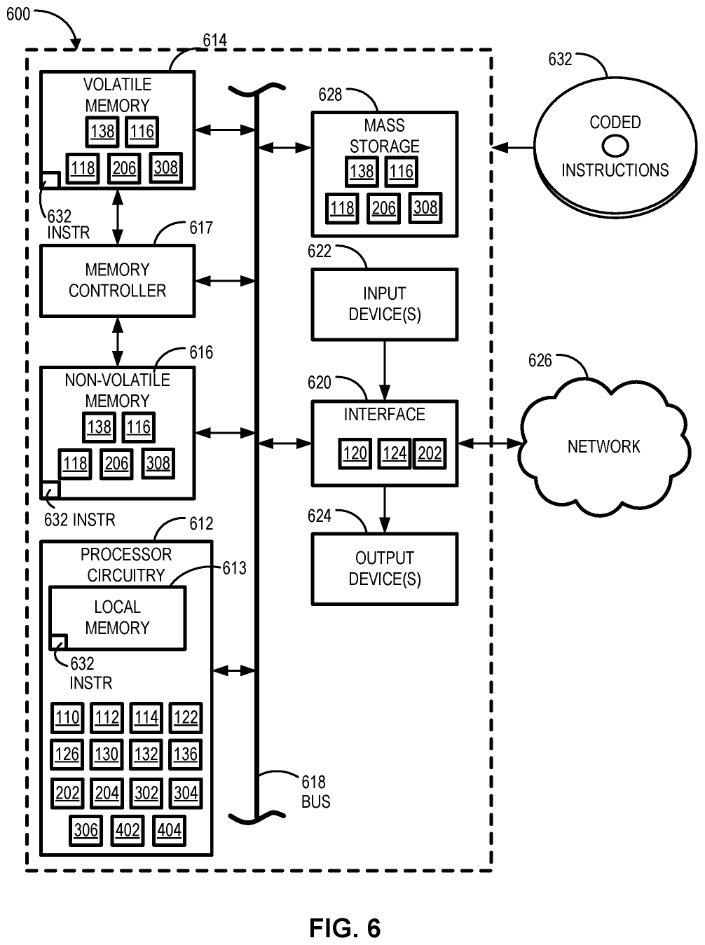

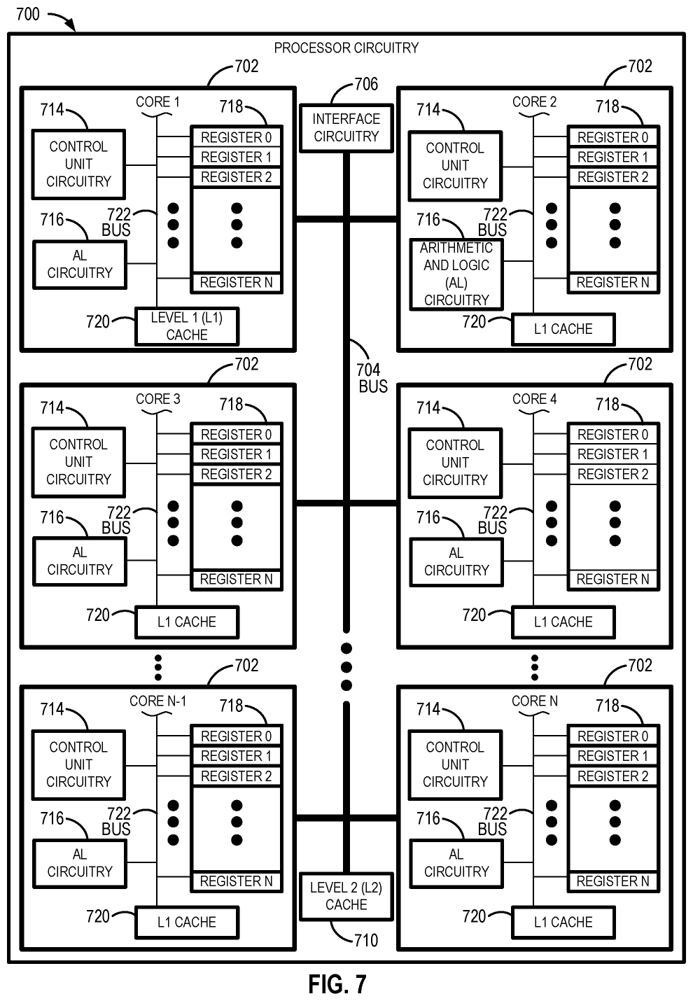

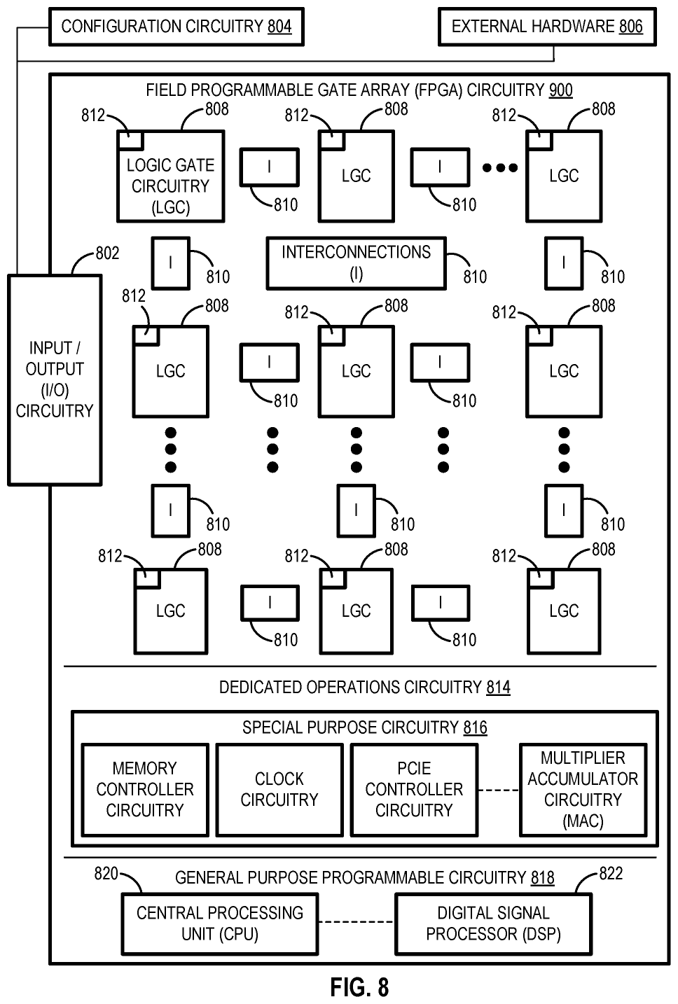

In some examples, the cache scrape trigger rule controller 110 includes means for defining cache scrape trigger rules. For example, the means for defining may be implemented by rule generator circuitry such as the rule generator 204. In some examples, the rule generator 204 may be instantiated by programmable circuitry such as the example programmable circuitry 612 of FIG. 6. For instance, the rule generator 204 may be instantiated by the example microprocessor 700 of FIG. 7 executing machine executable instructions such as those implemented by at least blocks 512, 548, 550 of FIG. 5. In some examples, the rule generator 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the rule generator 204 may be instantiated by any other combination of hardware, software, and/or firmware. For example, the rule generator 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the cache software monitor 122 of FIG. 1 to monitor software trigger conditions based on cache scraping rules to perform cache scraping. The cache software monitor 122 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the cache software monitor 122 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example cache software monitor 122 includes an example cache monitor configuration agent 302, an example software trigger monitor 304, an example cache monitor capture agent 306, and an example software repository 308. The example cache software monitor 122 monitors for software conditions based on software-based cache scrape trigger rules and triggers a cache scrape when a condition is satisfied. In addition, the example cache monitor configuration agent 302 configures the hardware registers 132 in a hardware layer by writing hardware-based cache scrape trigger rules to the hardware registers 132.

The example software trigger monitor 304 detects cache scraping event based on one or more conditions in the software layer 104 satisfying a software based cache scrape trigger rule. When the one or more conditions are satisfied, the example software trigger monitor 304 triggers a cache scraping task to collect cache data by sending a request to the hardware layer 106 to scrape cache data from the cache 134. The request to scrape cache can be in the form of setting a bit or a value in a hardware register 132 that causes the cache hardware monitor 130 to perform a cache scraping task.

The example cache monitor capture agent 306 forwards cache data to the analytics and management system 102 to generate a cache report.

The example software repository 308 stores software-based cache scrape trigger rules for the software layer 104.

In some examples, the cache software monitor 122 includes means for writing a cache scrape trigger rule to a hardware register. For example, the means for writing a cache scrape trigger rule may be implemented by cache monitor configuration agent circuitry such as the cache monitor configuration agent 302. In some examples, the cache monitor configuration agent 302 may be instantiated by programmable circuitry such as the example programmable circuitry 612 of FIG. 6. For instance, the cache monitor configuration agent 302 may be instantiated by the example microprocessor 700 of FIG. 7 executing machine executable instructions such as those implemented by at least blocks 514, 516, 530 of FIG. 5. In some examples, the cache monitor configuration agent 302 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the cache monitor configuration agent 302 may be instantiated by any other combination of hardware, software, and/or firmware. For example, the cache monitor configuration agent 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cache software monitor 122 includes means for detecting a cache scraping event based on condition in the software layer. For example, the means for detecting a cache scraping event may be implemented by software trigger monitor circuitry such as the software trigger monitor 304. In some examples, the software trigger monitor 304 may be instantiated by programmable circuitry such as the example programmable circuitry 612 of FIG. 6. For instance, the software trigger monitor 304 may be instantiated by the example microprocessor 700 of FIG. 7 executing machine executable instructions such as those implemented by at least blocks 532, 534, 536, 540 of FIG. 5. In some examples, the software trigger monitor 304 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the software trigger monitor 304 may be instantiated by any other combination of hardware, software, and/or firmware. For example, the software trigger monitor 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 4 is a block diagram of an example implementation of the cache hardware monitor 130 of FIG. 1 to monitor hardware trigger conditions based on cache scraping rules to perform cache scraping. The cache hardware monitor 130 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the cache hardware monitor 130 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example cache hardware monitor 130 includes an example hardware trigger monitor 402 and an example cache scraper 404. The example hardware trigger monitor 402 performs monitoring based on the cache scrape trigger rules defined in the hardware registers 132. The example cache hardware monitor 130 monitors for conditions in the hardware layer 104 that are defined in one or more cache scrape trigger rules. For example, the hardware trigger monitor 402 detects a cache scraping event during execution of a workload based on conditions in the hardware layer 106 satisfying a cache scrape trigger rule.

The example cache scraper 404 scrapes cache data from the cache 134 during execution of a workload. The example cache scraper 404 scrapes cache data by scraping one or more cache lines in the cache 134. The example cache scraper 404 extracts cache content and data from the cache 134 and writes the cache data to an example memory 138. The cache data in the memory 138 is accessed by the report generator 112 to generate a cache report.

In some examples, the cache hardware monitor 130 includes means for detecting a cache scraping event based on conditions in the hardware layer. For example, the means for detecting conditions in the hardware layer may be implemented by hardware trigger monitor circuitry such as the hardware trigger monitor 402. In some examples, the hardware trigger monitor 402 may be instantiated by programmable circuitry such as the example programmable circuitry 612 of FIG. 6. For instance, the hardware trigger monitor 402 may be instantiated by the example microprocessor 700 of FIG. 7 executing machine executable instructions such as those implemented by at least blocks 522, 524 of FIG. 5. In some examples, the hardware trigger monitor 402 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the hardware trigger monitor 402 may be instantiated by any other combination of hardware, software, and/or firmware. For example, the hardware trigger monitor 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cache hardware monitor 130 includes means for scraping cache data from cache in hardware. For example, the means for scraping cache data may be implemented by cache scraper circuitry such as the cache scraper 404. In some examples, the cache scraper 404 may be instantiated by programmable circuitry such as the example programmable circuitry 612 of FIG. 6. For instance, the cache scraper 404 may be instantiated by the example microprocessor 700 of FIG. 7 executing machine executable instructions such as those implemented by at least blocks 526, 528, 538 of FIG. 5. In some examples, the cache scraper 404 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the cache scraper 404 may be instantiated by any other combination of hardware, software, and/or firmware. For example, the cache scraper 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While example manners of implementing the cache scrape trigger rule controller 110 of FIG. 1 is illustrated in FIG. 2, the cache software monitor 122 of FIG. 1 is illustrated in FIG. 3 and the cache hardware monitor 130 of FIG. 1 is illustrated in FIG. 4, one or more of the elements, processes, and/or devices illustrated in FIGS. 2-4 may be combined, divided, re-arranged, omitted, eliminated, and/or implemented in any other way. Further, the example user interface 202, the example rule generator 204, the example policies 206 and/or, more generally, the example cache scrape trigger rule controller 110 of FIG. 2, the example cache monitor configuration agent 302, the example software trigger monitor 304, the example cache monitor capture agent, and/or, more generally, the example cache software monitor 122 of FIG. 3, and the example hardware trigger monitor 403, the example cache scraper 404, and/or, more generally, the example cache hardware monitor 130 of FIG. 4, may be implemented by hardware alone or by hardware in combination with software and/or firmware. Thus, for example, any of the example user interface 202, the example rule generator 204, the example policies 206, and/or, more generally, the example cache scrape trigger rule controller 110, the example cache monitor configuration agent 302, the example software trigger monitor 304, the example cache monitor capture agent, and/or, more generally, the example cache software monitor 122, and the example hardware trigger monitor 403, the example cache scraper 404, and/or, more generally, the example cache hardware monitor 130, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example cache scrape trigger rule controller 110 of FIG. 2, cache software monitor 122 of FIG. 3, and cache hardware monitor 130 of FIG. 4 may include one or more elements, processes, and/or devices in addition to, or instead of, those illustrated in FIGS. 2-4, and/or may include more than one of any or all of the illustrated elements, processes, and devices.

A flowchart representative of example machine readable instructions, which may be executed by programmable circuitry to implement and/or instantiate the cache scrape trigger rule controller 110 of FIG. 2, the cache software monitor 122 of FIG. 3, and the cache hardware monitor 130 of FIG. 4 and/or representative of example operations which may be performed by programmable circuitry to implement and/or instantiate the cache scrape trigger rule controller 110 of FIG. 2, the cache software monitor 122 of FIG. 3, and the cache hardware monitor 130 of FIG. 4 are shown in FIG. 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example cache scrape trigger rule controller 110, the example cache software monitor 122, and the example cache hardware monitor 130 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to detect a cache scraping event during execution of a workload based on conditions satisfying a cache scrape trigger rule and scrape cache data from the cache 134 (FIG. 1). The example flowchart of FIG. 5 includes an analytics and management process 502, a software process 504, and a hardware process 506. The example analytics and management process 502 is implemented by the analytics and management system 102 of FIG. 1. The example software process 504 is implemented by the software layer 104 of FIG. 1. The example hardware process 506 is implemented by the hardware layer 106 of FIG. 1.

The example machine-readable instructions and/or the example operations 500 of FIG. 5 begin at block 512, at which the example cache scrape trigger rule controller 110 (FIG. 2) defines cache scrape trigger rule as a policy. The example driver 126 (FIG. 1) determines whether the cache scrape trigger rule is for the software layer 104 (FIG. 1) or the hardware layer 106 (FIG. 1) (block 514). If the cache scrape trigger rule is a hardware-based cache scrape trigger rule for the hardware layer 106 (block 514: HARDWARE), control proceeds to block 516 at which the example driver 126 sends the cache scrape trigger rule to the hardware layer 106 via an example API 124 (FIG. 1). For example, the API 124 communicates with the hardware layer 106 via a secure enclave or trusted domain. This decreases the likelihood that malicious code in the software layer 104 can access hardware components in the hardware layer 106. The example hardware registers 132 (FIG. 1) receives the cache scrape trigger rule (block 518). For example, the hardware registers 132 receive the cache scrape trigger rule from the API 124 through the secure enclave or the trusted domain. The example driver 126 configures one or more of the example hardware registers 132 based on the cache scrape trigger rule (block 520). For example, the example device driver 126 writes parameter values in the hardware register(s) 132 based on criteria or conditions specified in the cache scrape trigger rule. The example hardware trigger monitor 402 (FIG. 4) monitors for hardware conditions during execution of a workload (block 522). The example cache hardware monitor 130 (FIG. 4) determines whether a cache scrape event is detected (block 524). For example, the hardware trigger monitor 402 compares detected hardware conditions to criteria in one or more cache scrape trigger rules represented in the hardware register(s) 132 to determine whether the hardware condition(s) satisfy a cache scrape trigger rule. If a cache scrape event is not detected (block 524: NO), control returns to block 522 to continue monitoring for hardware conditions. If a cache scrape event is detected (block 524: YES), control proceeds to block 526 at which the cache hardware monitor 130 triggers a cache scraping task. The example cache scraper 404 scrapes cache data from the cache 134 (block 528).

Returning to block 514, if the cache scrape trigger rule is a software-based cache scrape trigger rule for the software layer 104 (block 514: SOFTWARE), control proceeds to block 530 at which the example cache monitor configuration agent 302 (FIG. 3) writes the cache scrape trigger rule to the example software repository 308 (FIG. 3). The example software trigger monitor 304 (FIG. 3) monitors for software conditions during execution of a workload (block 532). For example, the software trigger monitor 304 compares the detected software conditions against one or more cache scrape trigger rules in the software repository 308. The example software trigger monitor 304 determines if a cache scrape event is detected (block 534). For example, the software trigger monitor 304 determines whether one or more detected software conditions satisfy criteria specified in a cache scrape trigger rule. If a cache scrape event is not detected (block 534: NO), control returns to block 532 at which the example software trigger monitor 304 continues to monitor for software conditions. If a cache scrape event is detected (block 534: YES), control proceeds to block 536 at which the software trigger monitor 304 sends a request to the hardware layer 106 to perform a cache-scraping task. For example, the software trigger monitor 304 may send a cache scrape request to the cache hardware monitor 130 via the API 124 to perform a cache scrape operation. The example cache scraper 404 scrapes cache data from the cache 134 (block 528).

The example cache scraper 404 writes the cache data to the memory 138 (block 538). The example cache monitor capture agent 306 (FIG. 3) access the cache data (block 540). The example report generator 112 (FIG. 1) maps the cache data to the corresponding cache scrape event (block 542). For example the report generator 112 may map the cache data to a timestamp, process identifier, workload identifier, a cache identifier and/or a cache scrape event identifier. The timestamp is indicative of a time and date at which the cache scrape was performed. The process identifier corresponds to a process thread associated with the scraped cache data. The workload identifier identifies the workload corresponding to the scraped cache data. The cache identifier identifies a specific cache that was scraped. The cache scrape event identifier identifies a particular cache scrape task or cache scrape operation. The example report generator 112 generates a cache report (block 544). The example resource orchestrator 114 (FIG. 1) manages cache resources based on the cache report (block 546). As described above in conjunction with FIG. 1, the resource orchestrator 114 can re-configure how cache is used by applications and/or processes to, for example, mitigate the effects of noisy neighbors. The example resource orchestrator 114 can ensure that the cache does not contain outdated or inaccurate information that could adversely affect SLA compliance. The cache report also provides information of which cache data to compress to more efficiently use storage space and cache frequently accessed data. The example instructions and/or operations of FIG. 5 end.

Returning to block 512, the rules defined by the cache scrape trigger rule controller 110 can also apply to another cache resource. The example resource orchestrator 114 determines whether the cache scrape trigger rule applies to another cache resource (block 548). If the cache scrape trigger rule applies to another cache resource (block 548: YES), control proceeds to block 550 at which the resource orchestrator 114 sends the cache scrape trigger rule to another cache resource which can be in a remote location or can be another local cache on the computer system. If the cache scrape trigger rule does not apply to another cache resource (block 548: NO), the example instructions and/or operations of FIG. 5 end.

FIG. 6 is a block diagram of an example programmable circuitry platform 600 structured to execute and/or instantiate the example machine-readable instructions and/or the example operations of FIG. 5 to implement the cache scrape trigger rule controller 110 of FIG. 2, the cache software monitor 122 of FIG. 3, and the cache hardware monitor 130 of FIG. 4. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example cache scrape trigger rule controller 110, the example report generator 112, the example resource orchestrator 114, the example cache software monitor 122, the example driver 126, the example cache hardware monitor 130, the example hardware register(s) 132, the example cache monitor filter 136, the example rule generator 204, the example cache monitor configuration agent 302, the example software trigger monitor 304, the example cache monitor capture agent 306, the example hardware trigger monitor 402, and the example cache scraper 404.

The programmable circuitry 612 of the illustrated example includes a local memory 613 (e.g., the cache 134). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616. The main memory 614 may implement the memory 138 of FIG. 1. In example FIG. 6, the example cache scrape trigger rules repository 116, the example aggregated scraping results 118, the example policies repository 206 and the example software repository 308 may be implemented by the volatile memory 614, the non-volatile memory 616, and/or the mass storage discs or devices 628.

The programmable circuitry platform 600 of the illustrated example also includes interface circuitry 620. In example FIG. 6, the example data interface 120, the example API 124 and the example user interface 202 may be implemented by the interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowchart of FIG. 5 to effectively instantiate the circuitry of FIG. 2 as logic circuits to perform operations corresponding to those machine readable instructions. In some such examples, the circuitry of FIGS. 2-4 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 5. As such, the FPGA circuitry 800 may be configured and/or structured to effectively instantiate some or all of the operations/functions corresponding to the machine readable instructions of the flowchart of FIG. 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIG. 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable, or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIG. 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart of FIG. 5 to perform first operation(s)/function(s), the FPGA circuitry 800 of FIG. 8 may be configured and/or structured to perform second operation(s)/function(s) corresponding to a second portion of the machine readable instructions represented by the flowchart of FIG. 5, and/or an ASIC may be configured and/or structured to perform third operation(s)/function(s) corresponding to a third portion of the machine readable instructions represented by the flowchart of FIG. 5.

It should be understood that some or all of the circuitry of FIGS. 2-4 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIGS. 2-4 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIGS. 2-4 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

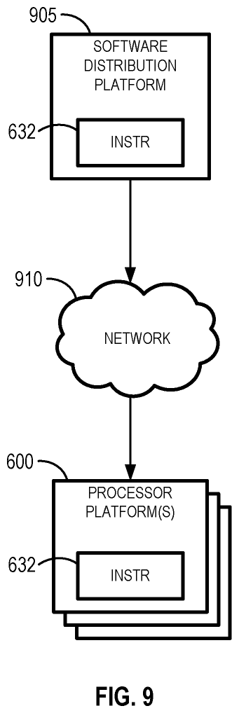

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIG. 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 5, may be downloaded to the example programmable circuitry platform 600, which is to execute the machine readable instructions 632 to implement the example cache scrape trigger rule controller 110, the example cache software monitor 112, and the example cache hardware monitor 130. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that scrape cache data from cache in hardware during execution of a workload. Disclosed systems, apparatus, articles of manufacture, and methods improve the efficiency of using a computing device by implementing a cache software monitor and a cache hardware monitor to detect cache scrape events based on various conditions satisfying one or more cache scrape trigger rules during execution of a workload. A trigger for a cache scrape task to scrape cache data from cache in hardware is generated when a cache scrape event is detected. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to scrape cache data from cache in hardware during execution of a workload are disclosed herein. Further examples and combinations thereof include the following: Example 1 includes an apparatus comprising a trigger monitor to detect an event satisfying a cache scrape trigger rule during execution of a workload, and a cache scraper to scrape cache data from cache in hardware during the execution of the workload.

Example 2 includes the apparatus of example 1, wherein the cache scrape trigger rule is defined as a policy by an orchestrator.

Example 3 includes the apparatus of example 1, wherein the cache scrape trigger rule is represented in a hardware register.

Example 4 includes the apparatus of example 3, wherein the hardware register is to receive the cache scrape trigger rule from a driver via an application programming interface (API).

Example 5 includes the apparatus of example 3, wherein the hardware register is to receive the cache scrape trigger rule from a driver through a secure enclave.

Example 6 includes the apparatus of example 1, wherein the cache scrape trigger rule includes a timing parameter and a cache region parameter, the cache region parameter indicative of a portion of the cache.

Example 7 includes the apparatus of example 1, wherein the cache scraper is to write the cache data to memory, the cache data to be accessed by a report generator to generate a cache report, the cache report to represent an association between a virtual memory address corresponding to the workload and a physical memory address.

Example 8 includes the apparatus of example 1, wherein the trigger monitor is to perform monitoring based on a plurality of cache scrape trigger rules defined in a plurality of hardware registers.

Example 9 includes a method comprising detecting an event satisfying a cache scrape trigger rule during execution of a workload, and scraping cache data from cache in hardware during the execution of the workload.

Example 10 includes the method of example 9, wherein the cache scrape trigger rule is defined by an orchestrator as a policy.

Example 11 includes the method of example 9, wherein the cache scrape trigger rule is represented in a hardware register.

Example 12 includes the method of example 11, wherein the hardware register is to receive the cache scrape trigger rule from a driver via an application programming interface (API).

Example 13 includes the method of example 11, wherein the hardware register is to receive the cache scrape trigger rule from a driver through a secure enclave.

Example 14 includes the method of example 9, wherein the cache scrape trigger rule includes a timing parameter and a cache region parameter, the cache region parameter indicative of a portion of the cache.

Example 15 includes the method of example 9, including writing the cache data to memory, and generating a cache report based on the cache data, the cache report to represent an association between a virtual memory address corresponding to the workload and a physical memory address.

Example 16 includes a non-transitory machine readable storage medium comprising instructions to cause programmable circuitry to at least write a cache scrape trigger rule parameter through an application programming interface in a software layer to a hardware register in a hardware layer, the cache scrape trigger rule parameter to trigger a cache scraping task to collect cache data from cache in the hardware layer, and cause a report generator to generate a cache report based on the cache data, the cache report indicative of an association between a virtual memory address corresponding to a workload and a physical memory address.

Example 17 includes the non-transitory machine readable storage medium of example 16, wherein the instructions are to cause the programmable circuitry to detect an event satisfying the cache scrape trigger rule parameter during execution of the workload.

Example 18 includes the non-transitory machine readable storage medium of example 17, wherein the cache report is to map the cache data to the event.

Example 19 includes the non-transitory machine readable storage medium of example 16, wherein the instructions are to cause the programmable circuitry to perform monitoring based on a plurality of cache scrape trigger rules defined in a plurality of hardware registers.

Example 20 includes the non-transitory machine readable storage medium of example 16, wherein the cache scrape trigger rule parameter is defined as a policy by an orchestrator.

Example 21 includes the non-transitory machine readable storage medium of example 20, wherein the instructions are to cause the programmable circuitry to apply the policy to a second cache, the second cache including a remote cache that is accessed through a network interface.

Example 22 includes a method comprising during execution of a workload, sending a request to a hardware layer to scrape cache data from cache in hardware, and generating a cache report, the cache report to represent an association between a virtual memory address corresponding to the workload and a physical memory address.

Example 23 includes the method of example 22, wherein the sending of the request to the hardware layer is performed when a cache scrape trigger rule is satisfied.

Example 24 includes the method of example 23, wherein the cache scrape trigger rule is defined as a policy by an orchestrator.

Example 25 includes the method of example 24, including applying the policy to a second cache, the second cache including at least one of a local cache or a remote cache that is accessed through a network interface.

Example 26 includes the method of example 22, including detecting an event satisfying a cache scrape trigger rule during the execution of the workload.

Example 27 includes the method of example 22, including mapping the cache data to an event, and managing cache resources based on the cache report.

Example 28 includes the method of example 27, wherein the managing of the cache resources is based on at least one of 1) a degree of contention for the cache resources assessed by measuring cache miss rates, 2) a cache age corresponding to a duration of the data in the cache, or 3) sharing of the cache data across a plurality of applications.

Example 29 includes an apparatus comprising interface circuitry, machine readable instructions, and programmable circuitry to at least one of instantiate or execute the machine readable instructions to during execution of a workload, send a request to a hardware layer to scrape cache data from cache, and generate a cache report, the cache report to represent an association between a virtual memory address corresponding to the workload and a physical memory address.

Example 30 includes the apparatus of example 29, wherein the request to the hardware layer is after a cache scrape trigger rule is satisfied.

Example 31 includes the apparatus of example 29, wherein the programmable circuitry is to detect an event satisfying a cache scrape trigger rule during the execution of the workload.

Example 32 includes the apparatus of example 29, wherein the programmable circuitry is to map the cache data to an event, and manage cache resources based on the cache report.

Example 33 includes the apparatus of example 32, wherein the management of the cache resources is based on at least one of 1) a degree of contention for the cache resources represented by a cache miss rate, 2) a cache age corresponding to a duration of the cache data in the cache, or 3) sharing of the cache data across a plurality of applications.

Example 34 includes the apparatus of example 33, wherein based on a high degree of contention, the instructions are to cause the programmable circuitry to evict a portion of cache after a period of time.

Example 35 includes the apparatus of example 29, wherein the programmable circuitry is to monitor one or more events based on a plurality of cache scrape trigger rules defined in a plurality of hardware registers.

Example 36 includes the apparatus of example 29, wherein, based on the cache report, the instructions are to cause the programmable circuitry to at least one of 1) maintain the cache data in compliance with a service level agreement (SLA), 2) reconfigure cache usage based on relative spread of the cached data for different applications, 3) compress the cache data, or 4) disable caching.

Example 37 includes the apparatus of example 31, wherein when the event includes context switching causing cache misses, the instructions are to cause the programmable circuitry to at least one of 1) assign a central processing unit core to a frequently used process, or 2) evict data with poor spatial or temporal locality.

Example 38 includes the apparatus of example 37, wherein the programmable circuitry is to lock data in the cache for the frequently used process for a period of time based on the cache report.

Example 39 includes the apparatus of example 29, wherein the instructions are to cause the programmable circuitry to increase cache per core or increase bandwidth per core based on the cache report.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a trigger monitor to detect an event satisfying a cache scrape trigger rule during execution of a workload; and
a cache scraper to scrape cache data from cache in hardware during the execution of the workload.

2. The apparatus of claim 1, wherein the cache scrape trigger rule is defined as a policy by an orchestrator.

3. The apparatus of claim 1, wherein the cache scrape trigger rule is represented in a hardware register.

4. The apparatus of claim 3, wherein the hardware register is to receive the cache scrape trigger rule from a driver via an application programming interface (API).

5. The apparatus of claim 3, wherein the hardware register is to receive the cache scrape trigger rule from a driver through a secure enclave.

6. The apparatus of claim 1, wherein the cache scrape trigger rule includes a timing parameter and a cache region parameter, the cache region parameter indicative of a portion of the cache.

7. The apparatus of claim 1, wherein the cache scraper is to write the cache data to memory, the cache data to be accessed by a report generator to generate a cache report, the cache report to represent an association between a virtual memory address corresponding to the workload and a physical memory address.

8. The apparatus of claim 1, wherein the trigger monitor is to perform monitoring based on a plurality of cache scrape trigger rules defined in a plurality of hardware registers.

9. A method comprising:
detecting an event satisfying a cache scrape trigger rule during execution of a workload; and
scraping cache data from cache in hardware during the execution of the workload.

10. (canceled)

11. The method of claim 9, wherein the cache scrape trigger rule is represented in a hardware register.

12-14. (canceled)

15. The method of claim 9, including:
writing the cache data to memory; and
generating a cache report based on the cache data, the cache report to represent an association between a virtual memory address corresponding to the workload and a physical memory address.

16. A non-transitory machine readable storage medium comprising instructions to cause programmable circuitry to at least:
write a cache scrape trigger rule parameter through an application programming interface in a software layer to a hardware register in a hardware layer, the cache scrape trigger rule parameter to trigger a cache scraping task to collect cache data from cache in the hardware layer; and
cause a report generator to generate a cache report based on the cache data, the cache report indicative of an association between a virtual memory address corresponding to a workload and a physical memory address.

17. The non-transitory machine readable storage medium of claim 16, wherein the instructions are to cause the programmable circuitry to detect an event satisfying the cache scrape trigger rule parameter during execution of the workload.

18. The non-transitory machine readable storage medium of claim 17, wherein the cache report is to map the cache data to the event.

19. The non-transitory machine readable storage medium of claim 16, wherein the instructions are to cause the programmable circuitry to perform monitoring based on a plurality of cache scrape trigger rules defined in a plurality of hardware registers.

20. The non-transitory machine readable storage medium of claim 16, wherein the cache scrape trigger rule parameter is defined as a policy by an orchestrator.

21. The non-transitory machine readable storage medium of claim 20, wherein the instructions are to cause the programmable circuitry to apply the policy to a second cache, the second cache including a remote cache that is accessed through a network interface.

22. A method comprising:
during execution of a workload, sending a request to a hardware layer to scrape cache data from cache in hardware; and
generating a cache report, the cache report to represent an association between a virtual memory address corresponding to the workload and a physical memory address.

23-26. (canceled)

27. The method of claim 22, including:
mapping the cache data to an event; and
managing cache resources based on the cache report.

28. (canceled)

29. An apparatus comprising:
interface circuitry;
machine readable instructions; and
programmable circuitry to at least one of instantiate or execute the machine readable instructions to:
during execution of a workload, send a request to a hardware layer to scrape cache data from cache; and
generate a cache report, the cache report to represent an association between a virtual memory address corresponding to the workload and a physical memory address.

30. The apparatus of claim 29, wherein the request to the hardware layer is after a cache scrape trigger rule is satisfied.

31. The apparatus of claim 29, wherein the programmable circuitry is to detect an event satisfying a cache scrape trigger rule during the execution of the workload.

32. The apparatus of claim 29, wherein the programmable circuitry is to:
map the cache data to an event; and
manage cache resources based on the cache report.

33. The apparatus of claim 32, wherein the management of the cache resources is based on at least one of 1) a degree of contention for the cache resources represented by a cache miss rate, 2) a cache age corresponding to a duration of the cache data in the cache, or 3) sharing of the cache data across a plurality of applications.

34. The apparatus of claim 33, wherein based on a high degree of contention, the instructions are to cause the programmable circuitry to evict a portion of cache after a period of time.

35. The apparatus of claim 29, wherein the programmable circuitry is to monitor one or more events based on a plurality of cache scrape trigger rules defined in a plurality of hardware registers.

36. The apparatus of claim 29, wherein, based on the cache report, the instructions are to cause the programmable circuitry to at least one of 1) maintain the cache data in compliance with a service level agreement (SLA), 2) reconfigure cache usage based on relative spread of the cached data for different applications, 3) compress the cache data, or 4) disable caching.

37. The apparatus of claim 31, wherein when the event includes context switching causing cache misses, the instructions are to cause the programmable circuitry to at least one of 1) assign a central processing unit core to a frequently used process, or 2) evict data with poor spatial or temporal locality.

38. The apparatus of claim 37, wherein the programmable circuitry is to lock data in the cache for the frequently used process for a period of time based on the cache report.

39. The apparatus of claim 29, wherein the instructions are to cause the programmable circuitry to increase cache per core or increase bandwidth per core based on the cache report.
